(19) United States
(12) Patent Application Publication
(10) Pub. No.: US 2023/0165743 A1
(43) Pub. Date: Jun. 1, 2023

(54) WIRELESS POWER AND CHARGING OF PATIENT SUPPORT FROM BED

(71) Applicant: Hill-Rom Services, Inc., Batesville, IN (US)

(72) Inventors: Gavin M. Monson, Oxford, OH (US); Jeff Scott Jelinek, Oldenburg, IN (US); Nolan D. Wanner, Clancy, MT (US); David Newkirk, Lawrenceburg, IN (US); Jonathan D. Turner, Dillsboro, IN (US); Jonathan Keith Moenter, Batesville, IN (US); Frank Sauser, Cincinnati, OH (US); Jnanesha Ramegowda, Batesville, IN (US)

(73) Assignee: Hill-Rom Services, Inc., Batesville, IN (US)

(21) Appl. No.: 18/073,205

(22) Filed: Dec. 1, 2022

Related U.S. Application Data
(60) Provisional application No. 63/284,965, filed on Dec. 1, 2021.

(51) Int. Cl. A61G 7/05; A61G 7/00; A61G 7/057; A61H 23/00; A61H 9/00; H02J 7/00; H02J 50/05; H02J 50/10; H02J 50/90; A61G 1/04

(52) U.S. Cl. CPC A61G 7/05; A61G 7/001; A61G 7/05776; A61H 23/006; A61H 9/0078; H02J 7/00032; H02J 50/05; H02J 50/10; H02J 50/90; H02J 7/0047; A61G 1/04; A61G 2205/60; A61H 2201/0146; A61H 2201/5097; A61H 2201/1238

(57) ABSTRACT

A power supply system for a facility includes a patient support apparatus with a controller and a patient support. A power source is operably coupled to the patient support apparatus. The controller is in communication with the power source. A transmitting assembly is coupled to the patient support apparatus and the power source. A receiving assembly is operably coupled to the patient support. The transmitting assembly wirelessly communicates with the receiving assembly to power the patient support. A locating feature is in communication with the controller of the patient support apparatus. The locating feature is configured to aid in aligning the power source on the patient support apparatus to indicate when the receiving assembly is in communication with the transmitting assembly.

### CROSS-REFERENCE TO RELATED APPLICATION

This application claims priority to and the benefit under 35 U.S.C. § 119(e) of U.S. Provisional Application No. 63/284,965, filed on Dec. 1, 2021, entitled “WIRELESS POWER AND CHARGING OF PATIENT SUPPORT FROM BED,” the disclosure of which is hereby incorporated herein by reference in its entirety.

### FIELD OF THE DISCLOSURE

The present disclosure generally relates to a patient support system, and more particularly to an autonomous system to wirelessly power and charge a patient support system, such as a stretcher or hospital bed, or a subsystem within the patient support system.

### SUMMARY OF THE DISCLOSURE

According to one aspect of the present disclosure, a power supply system for a facility includes a patient support apparatus with a controller and a patient support. A power source is operably coupled to the patient support apparatus. The controller is in communication with the power source. A transmitting assembly is coupled to the patient support apparatus and the power source. A receiving assembly is operably coupled to the patient support. The transmitting assembly wirelessly communicates with the receiving assembly to power the patient support. A locating feature is in communication with the controller of the patient support apparatus. The locating feature is configured to aid in aligning the power source on the patient support apparatus to indicate when the receiving assembly is in communication with the transmitting assembly.

According to another aspect of the present disclosure, a patient support apparatus powering system includes a frame, a patient support disposed on the frame, a wheel coupled to the frame and configured to engage a floor surface, and a controller. A rechargeable battery is coupled to a patient support apparatus and is in communication with the controller. A receiving assembly is coupled to the patient support and includes a locating feature that is operably coupled to the frame. The receiving assembly is in communication with the rechargeable battery. A transmitting assembly is operably coupled to the frame and includes a complementary locating feature that is configured to aid a caregiver in aligning the receiving assembly adjacent to the transmitting assembly such that the transmitting assembly is in electrical communication with the receiving assembly.

According to a third aspect of the present disclosure, a patient support apparatus includes a bed frame that has a support surface. A transmitting assembly is coupled to the bed frame, a mattress is selectively positioned on the support surface, and a controller is communicatively coupled to the transmitting assembly. A sensor assembly is coupled to the mattress and is configured to sense information about at least one of the mattress and a person positioned on the mattress. A receiving assembly is embedded within the mattress and is in communication with the sensor assembly. The receiving assembly is configured to selectively interact with the transmitting assembly via one of inductive coupling and capacitive coupling to power the sensor assembly.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of a medical bed and a support sling, according to the present disclosure;

FIG. 2 is a side cross-sectional view of a mattress disposed on a frame, according to the present disclosure;

FIG. 3 is a top perspective exploded view of a mattress having a pneumatic system, according to the present disclosure;

FIG. 4 is a side cross-sectional view of a microclimate management system disposed on a frame of a support apparatus, according to the present disclosure;

FIG. 5 is a block diagram of a charging system with a transmitting element coupled to a support apparatus, according to the present disclosure;

FIG. 6 is a side cross-sectional view of a mattress having a sensor assembly operably coupled to a receiving assembly, where the receiving assembly interacts with a transmitting element on a support surface of a support apparatus, according to the present disclosure;

FIG. 7 is a side cross-sectional view of a mattress having a sensor assembly operably coupled to a receiving assembly, where the receiving assembly interacts with a transmitting element on a siderail of a support apparatus, according to the present disclosure;

FIG. 8 is a cross-sectional view of a mattress having a pneumatic system, where the pneumatic system includes a pump and is associated with sensors that are each operably coupled with a receiving assembly, according to the present disclosure;

FIG. 9 is a side cross-sectional view of a mattress having a pneumatic system, where the pneumatic system includes a pump and is associated with sensors that are each operably coupled with corresponding receiving assemblies, according to the present disclosure;

FIG. 10 is a partial cross-sectional view of a microclimate management system having a blower operably coupled with a receiving assembly that interacts with a transmitting element coupled to a support apparatus, according to the present disclosure;

FIG. 11 is a block diagram of an information system for communicating data, according to the present disclosure;

FIG. 12 is a block diagram of a support apparatus wirelessly communicating with a local server via a wireless access transceiver, according to the present disclosure;

FIG. 13 is a block diagram of a support apparatus wirelessly communicating with a local server via wireless access points, according to the present disclosure;

FIG. 14 is a side cross-sectional view of a mattress disposed on a frame with locating features, according to the present disclosure;

FIG. 15 is a side cross-sectional view of a mattress disposed on a frame with locating features, according to the present disclosure;

FIG. 16 is a is a side cross-sectional view of a mattress disposed on a frame with locating features, according to the present disclosure;

FIG. 17 is a is a side cross-sectional view of a mattress disposed on a frame with locating features, according to the present disclosure;

FIG. 18 is a is a side cross-sectional view of a mattress disposed on a frame with locating features, according to the present disclosure;

FIG. 19 is a side perspective view of a medical bed with a mattress folded down to illustrate a transmitting and receiving assembly system, according to the present disclosure;

FIG. 20 is a side perspective view of a medical bed with a mattress folded down to illustrate a transmitting and receiving assembly system, according to the present disclosure;

FIG. 21 is a side perspective view of a medical bed with a mattress folded down to illustrate a transmitting and receiving assembly system, according to the present disclosure; and

FIG. 22 is a flow diagram of a mattress replacement system, according to the preset disclosure.

### DETAILED DESCRIPTION

The present illustrated embodiments reside primarily in combinations of method steps and apparatus components related to an autonomous system to wirelessly power and charge a patient support system, such as a stretcher or hospital bed. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

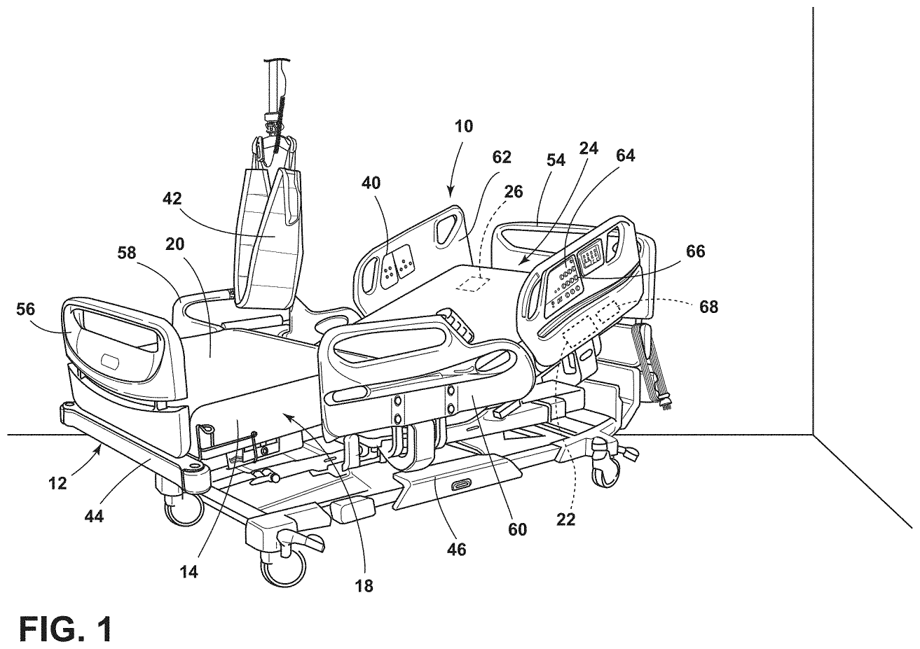

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to a surface closest to an intended viewer, and the term “rear” shall refer to a surface furthest from the intended viewer. However, it is to be understood that the disclosure may assume various alternative orientations, except where expressly specified to the contrary. It is also to be understood that the specific structures and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

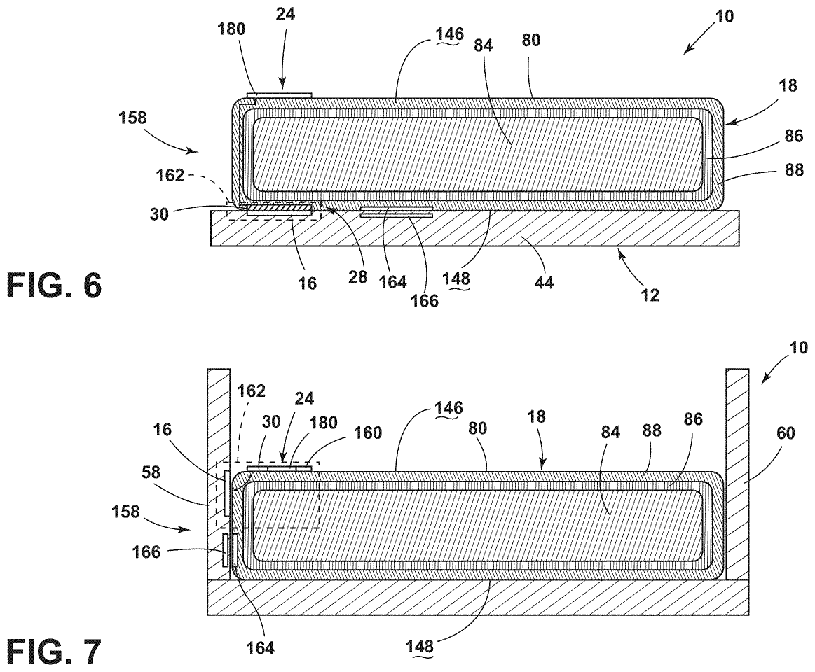

Referring to FIGS. 1-21, reference numeral 10 generally designates a patient support apparatus that includes a frame 12 that has a support surface 14. A transmitting assembly 15 that includes a transmitting element 16 (FIG. 6) is coupled to the frame 12. A mattress or patient support 18 is selectively positioned on the support surface 14. The mattress 18 includes a cover 20. A controller 22 is communicatively coupled to the transmitting element 16. A sensor assembly 24 (FIGS. 6 and 7) is coupled to the mattress 18. The sensor assembly 24 includes a sensor 26 configured to sense information about at least one of the mattress 18 and a person or a patient positioned on the mattress 18. A receiving assembly 28 is operably coupled to the mattress 18 and the sensor assembly 24. The receiving assembly 28 includes a receiving element 30, which is configured to selectively interact with the transmitting element 16 via at least one of a capacitive coupling and an inductive coupling to provide power to various components of the patient support apparatus 10, via a power supply system, including the sensor assembly 24 and features of the patient support 18.

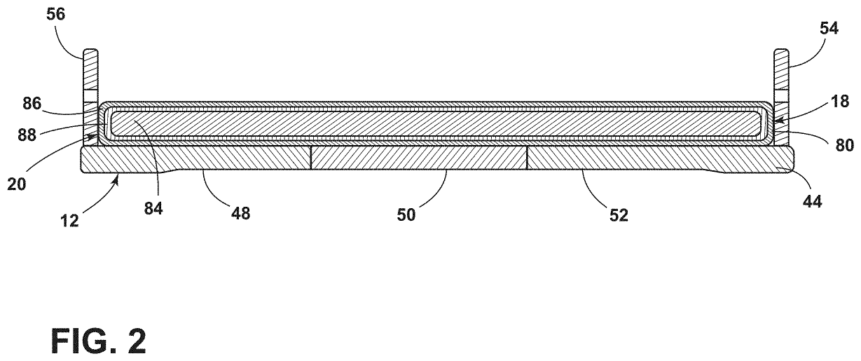

With reference to FIGS. 1 and 2, during a stay at a medical facility or in other healthcare settings, the patient may be positioned on or supported by the patient support apparatus 10. In the exemplary patient room illustrated in FIG. 1, there are two support apparatuses 10, with one patient support apparatus 10 configured as a medical bed 40 and the other patient support apparatus 10 configured as a support sling 42. It is contemplated that the patient support apparatus 10 may be a medical bed, a stretcher, a mattress, a coverlet, a mattress pad, an examination table, an operating table, a recliner, a support sling, a lift sheet, or other suitable structures for supporting the patient.

The patient support apparatus 10 configured as the medical bed 40 includes an upper frame 44 and a base frame 46, that collectively form the frame 12. The upper frame 44 is generally adjustable relative to the base frame 46 (e.g., height, tilt, etc.). Additionally, the upper frame 44 includes multiple segments 48, 50, 52 that are independently movable relative to each other. The independently movable segments 48, 50, 52 allow for various portions of the upper frame 44 to be adjusted, such as, for example, an elevated head region or elevated foot region. The segments 48, 50, 52 collectively form the support surface 14 for supporting the mattress 18.

Additionally, the frame 12 includes a headboard 54 that is selectively coupled to a head end of the patient support apparatus 10 and a footboard 56 that is selectively coupled to a foot end of the patient support apparatus 10. The headboard 54 and the footboard 56 may each be fixedly coupled to the frame 12, or alternately may be removed from the patient support apparatus 10 to provide increased access to the patient. The patient support apparatus 10 includes multiple base region siderails 58, 60 and head region siderails 62, 64, which may also be considered part of the frame 12. Each of the base region siderails 58, 60 and the head region siderails 62, 64 are operable between raised and lowered positions to selectively allow access to the patient and ingress and egress from the patient support apparatus 10. It is contemplated that the patient support apparatus 10 may include a plurality of wheels coupled to the frame 12 that are configured to engage a floor surface of the medical facility to support mobility of the patient support apparatus 10.

In various examples, a user interface 66 is coupled to at least one of the siderails 58, 60, 62, 64. The user interface 66 may include buttons and other selectable features that allow a caregiver or the patient to adjust aspects of the patient support apparatus 10, such as the position of the upper frame 44. Additionally or alternatively, the patient support apparatus 10 may include a position sensor 68 that senses the position of the upper frame 44. The position sensor 68 may sense the position of the upper frame 44 relative to the base frame 46, the position of the segments 48, 50, 52 of the upper frame 44, or a combination thereof.

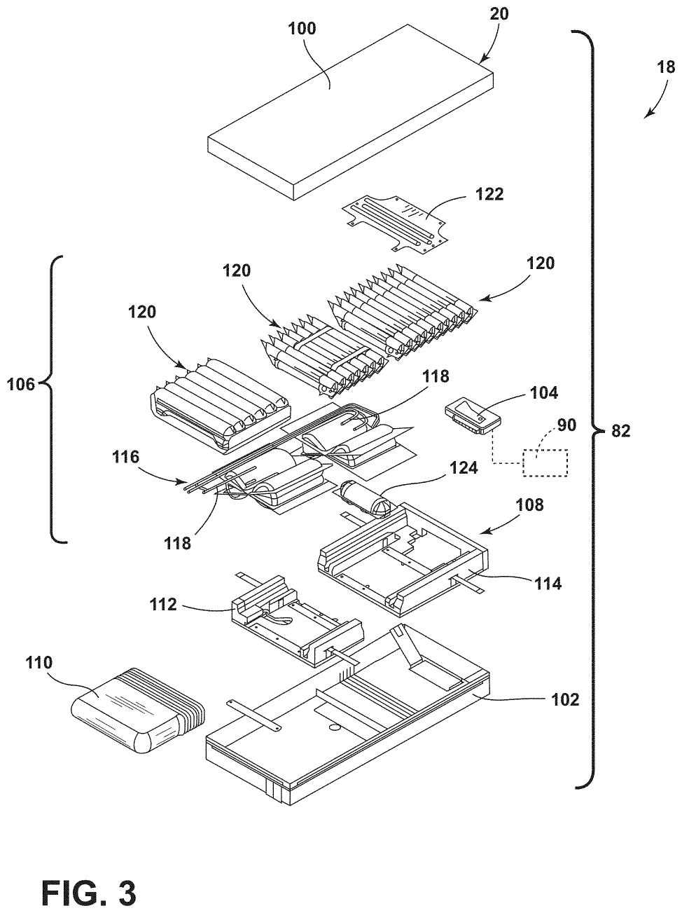

Referring still to FIGS. 1 and 2, as well as FIG. 3, various components or accessories may be associated with the medical bed 40, such as, for example, the mattress 18, which is selectively positioned on the upper frame 44. The mattress 18 may be a non-powered mattress 80 or a powered mattress 82. In non-powered mattress 80 configurations, the mattress 18 generally includes the cover 20, which surrounds a core 84. The core 84 may be foam, springs, pads, or any other suitable material that supports and provides comfort to the patient disposed on the mattress 18.

As shown in FIG. 2, the cover 20 may include multiple layers including a top ticking 86 and a bottom ticking 88. Generally, the top ticking 86 is an outer layer that abuts the upper frame 44 and the bottom ticking 88 is disposed between the core 84 and the top ticking 86. Generally, the top ticking 86 and the bottom ticking 88 are constructed of polyurethane coated nylon, or similar materials, which protect the mattress 18 from fluid penetration. The top ticking 86 may also have anti-skid portions to retain the mattress 18 in place on the patient support apparatus 10. The top and bottom tickings 86, 88 (e.g., the cover 20) are generally removable from the core 84 to be removed, interchanged, or replaced, such as for cleaning. It is contemplated that the cover 20 may have additional layers without departing from the teachings herein.

Referring still to FIG. 3, in configurations that include the powered mattress 82, the mattress 18 generally includes a controller 90 having a processor 92, a memory 94, and other control circuitry. Instructions or routines 96 are stored in the memory 94 and executable by the processor 92. The mattress 18 may be communicatively coupled to the patient support apparatus 10 via wired or wireless communication protocols. The powered mattress 82 may include a pneumatic system 98 in communication with the controller 90 and enclosed within the cover 20, which may include an upper cover portion 100 and a lower cover portion 102 to allow more convenient access to the pneumatic system 98.

With reference again to FIG. 3, the pneumatic system 98 generally includes a pump 104 in fluid communication with multiple bladders 106. The pump 104 adjusts the amount of fluid within each bladder 106 to adjust the firmness of the mattress 18 or provide various therapies. Each of the bladders 106 are operable between a deployed state, which is generally an inflated or expanded state, and a non-deployed state, which is generally a deflated or compressed state. The mattress 18 may include a shell assembly 108 that includes multiple shells 110, 112, 114 to retain the bladders 106 in selected regions of the mattress 18 and provide support for the pneumatic system 98. The powered mattress 82 may be used for pressure therapy, for example, for pressure ulcer prevention, or other treatments for the patient on the patient support apparatus 10.

The pneumatic system 98 may include various types of bladders 106. For example, the bladders 106 may include rotation bladders 116 for continuous lateral rotation therapy. The rotation bladders 116 may be inflated or deflated in a certain pattern to provide a gentle, side-to-side movement of the patient for prevention and treatment of pulmonary and other health complications related to immobility, as well as treat or prevent pressure ulcers. Additionally or alternatively, the rotation bladders 116 may include turn bladders 118. The turn bladders 118 are utilized to rotate the patient along a longitudinal axis based on a predefined pattern of inflation or deflation of the turn bladders 118. The turn bladders 118 may be advantageous for assisting in a turn assist protocol, helping the caregiver turn the patient onto his or her side to change dressings or provide other treatment.

Referring still to FIG. 3, the pneumatic system 98 may also include support bladders 120 arranged over the rotation bladders 116. The support bladders 120 may support the patient lying on the mattress 18. The support bladders 120 may be utilized to provide alternating pressure therapy to the patient by independently inflating, maintaining, or deflating the bladders 106 in a pattern to relieve pressure points by cyclically dropping or elevating a pressure applied by the support bladders 120. Moreover, the pneumatic system 98 may include percussion and vibration therapy (PVT) bladders 122, which may be utilized to apply percussion and vibration therapy. The PVT bladders 122 drop and elevate in pressure at a rate sufficient to impart a vibration on the patient.

Additionally or alternatively, the pneumatic system 98 may also include fill bladders 124, which may be utilized to fill gaps between the support bladders 120 and the upper frame 44 as the segments 48, 50, 52 (FIG. 2) of the upper frame 44 articulate between different positions. As different segments 48, 50, 52 of the upper frame 44 move, the fill bladders 124 inflate or deflate to fill the gap or space between adjacent segments 48, 50, 52.

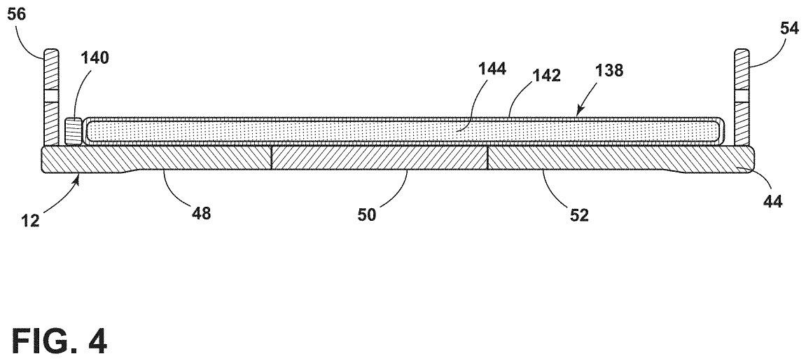

With reference to FIG. 4, in various examples, a microclimate management (MCM) system 138 is selectively coupled with the patient support apparatus 10. The MCM system 138 generally includes a blower 140, a top coverlet 142, and a spacer material 144 within the top coverlet 142. The blower 140 operates to direct or blow air through the spacer material 144. The MCM system 138 is generally disposed on a top surface 146 of the mattress 18, such that the patient may rest on the MCM system 138. While the patient is positioned on the MCM system 138, air is directed through the top coverlet 142. This configuration wicks away moisture from the skin of the patient by blowing air underneath the patient, which is advantageous for preventing skin conditions that may be caused by lying on the mattress 18 for an extended period of time. The MCM system 138 may be activated automatically when selectively coupled with the patient support apparatus 10, activated via the user interface 66 (FIG. 1) of the patient support apparatus 10, or activated through an application interface. The MCM system 138 may be used independently of, or in combination with, either of the non-powered mattress 80 and the powered mattress 82 configurations. It will be contemplated that in addition to the MCM system 138, a pressurization system may also be selectively coupled with the patient support apparatus 10.

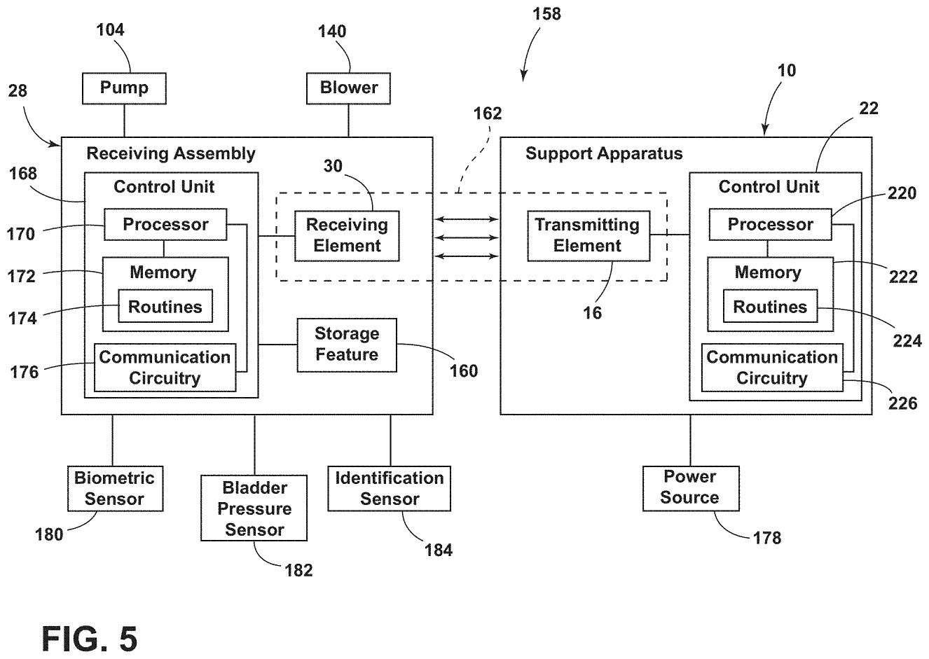

With reference to FIGS. 5-10, a charging system 158 may be utilized to wirelessly charge or power various components or accessories associated with the patient support apparatus 10, including the mattress 18, the sensor assembly 24, and the MCM system 138. Additionally, the charging system 158 may be utilized to power the sensor assembly 24 when the sensor assembly 24 is coupled to the patient. The charging system 158 may provide some or all of the electrical power for these components associated with the patient support apparatus 10 and the patient. The charging system 158 is advantageous for providing the electrical power through a mechanical barrier. The various systems of the patient support apparatus 10 may, when used in combination, utilize anywhere from 150-800 watts. The receiving assembly 28 ad the transmitting assembly 15 of the charging system 158 are generally configured and robust enough to transfer the requisite power from the transmitting assembly 15 in the bed frame 12 to the receiving assembly 28 disposed on, or embedded within, the patient support 18.

The charging system 158 generally includes the transmitting element 16 coupled with the patient support apparatus 10 or the mattress 18 and the separable receiving assembly 28 that includes the receiving element 30 and a storage feature 160. The receiving assembly 28 may be coupled with, for example, the mattress 18 or the MCM system 138, thereby reducing or eliminating direct mechanical connections between these components and the patient support apparatus 10. Further, the charging system 158 reduces connections between the patient and the patient support apparatus 10 or the mattress 18. A charging interface 162 is positioned between the transmitting assembly 15 and the receiving assembly 28 to wirelessly transmit power from the transmitting element 16 to the receiving element 30. The interface 162 is generally smooth and free of mechanical connections, electrical plugs, etc. Consequently, the interface 162 defines a clean site that increases septic control and enhances efficiency for a caregiver. Stated differently, the use of wireless power transfer to devices in a patient support apparatus (such as a bed or stretcher system), which may be physically removable, as set forth herein, is valuable because wireless power enables and simplifies the system as a whole, thereby maximizing septic control, caregiver convenience, and time-saving. Having a wireless power interface allows the surface to be totally encapsulated, which aids in the control of septic transfer and reduces caregiver workload by facilitating quick surface changes in the care environment.

The receiving assembly 28 generally includes a control unit 168 that has a processor 170, a memory 172, and other control circuitry. Instructions or routines 174 are stored in the memory 172 and executable by the processor 170. The control circuitry may include communication circuitry 176 for wireless communication. At least one routine 174 may be directed to collecting energy from the charging interface 162 and converting the energy for storage in the storage feature 160. The storage feature 160 may be a rechargeable battery including lead acid batteries, nickel cadmium batteries, nickel metal hydride batteries, or lithium ion batteries, depending on the desired life of the battery, the cost, efficiency, rechargeability, and charge time, etc., that is desired by the medical facility.

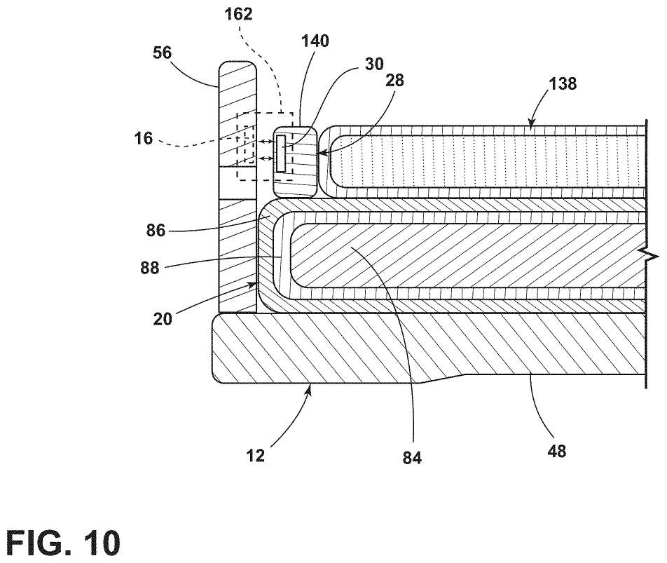

The charging system 158 is utilized to transfer power from the patient support apparatus 10 to the patient support 18, as well as to any accessory, component, or sensor 26 operably coupled with the receiving assembly 28. The transmitting element 16 is coupled to a surface of the patient support apparatus 10, as illustrated in FIGS. 5-10. In certain aspects, the transmitting element 16 may be embedded within the patient support apparatus 10 or otherwise received within a recess of the patient support apparatus 10 to provide a smooth surface, reducing pressure that may be applied to the patient through the mattress 18. In examples where the transmitting element 16 is coupled to the patient support apparatus 10, the transmitting element 16 may be coupled to the upper frame 44 (see FIG. 6), such as on a bed deck, a periphery of the frame 12, such the siderails 58, 60, 62, 64 (see FIG. 7) or the footboard 56 (see FIG. 10), or another practicable location on the patient support apparatus 10.

The transmitting element 16 and the receiving element 30 may be positioned to maximize the power transfer via the charging interface 162. Additionally or alternatively, the transmitting element 16 and the receiving element 30 may be positioned to form a strong coupling coefficient between the transmitting element 16 and the receiving element 30. The coupling coefficient is generally a strength of the interaction between the receiving element 30 and the transmitting element 16.

Referring still to FIGS. 5-10, the transmitting element 16 and the receiving element 30 selectively interact via the charging interface 162, which may include at least one of inductive coupling and capacitive coupling, to transfer power. The transmitting element 16 is a source configured to transfer power from a power source 178 to the receiving element 30 of the receiving assembly 28. The power source 178 is generally a power supply of the medical facility, but may also be a battery or rechargeable battery of the patient support apparatus 10. The transfer of power from the power source 178 to the receiving element 30 may charge (e.g., increases a state of charge) of the receiving assembly 28.

In inductive coupling examples, the transmitting element 16 and the receiving element 30 are generally configured as coils. An alternating current is generated through the transmitting element 16 to create an oscillating magnetic or electromagnetic field between the transmitting element 16 and the receiving element 30 in the charging interface 162. The oscillating magnetic or electromagnetic field passes through the receiving element 30 to induce an alternating voltage. The receiving assembly 28 includes circuitry to capture or extract power from the oscillating magnetic or electromagnetic field and convert the energy into electricity. The receiving assembly 28 also includes circuitry for directing and controlling the power supply to the storage feature 160.

In capacitive coupling examples, the transmitting element 16 and the receiving element 30 are generally configured as electrodes. An alternating voltage is applied to the transmitting element 16 by the power source 178 to generate an oscillating electric field. The oscillating electric field generally induces an alternating potential on the transmitting element 16. Capacitance is used for the transfer of power between the transmitting element 16 and the receiving element 30, with the space between the transmitting and receiving elements 16, 30 serving as a dielectric. The receiving assembly 28 includes circuitry to capture or extract power from the oscillating electric field and convert the energy into electricity. The receiving assembly 28 also includes circuitry for directing and controlling the power supplied to the storage feature 160. It is contemplated that other forms of wireless power transmission may be employed in the charging system 158 such as, for example, magnetic resonance, loose coupled resonance, and electromagnetic radiation, without departing the teachings herein.

When the receiving element 30 is positioned within a predefined distance from the transmitting element 16, the charging interface 162 is formed to wirelessly transmit power from the transmitting element 16 to the receiving element 30. Generally, for greater energy transfer, the predefined distance is less than or equal to about 5 mm. For lesser energy transfer, the predefined distance may be less than or equal to about 10 cm. The receiving element 30 collects energy from the charging interface 162, converts the energy, and transfers the energy to the storage feature 160, which can provide power separate from the active power transfer.

The alignment between the receiving element 30 and the transmitting element 16 affects the efficiency of the power transfer to the receiving assembly 28. When the transmitting element 16 is coupled to the patient support apparatus 10, the patient support apparatus 10 and the corresponding component may have complementary first and second locating features 164, 166 to assist in this alignment. For example, the mattress 18 or the MCM system 138 may include the first locating feature 164, which mates with the second locating feature 166 on the patient support apparatus 10 to bring the electrical power aspects (e.g., the receiving element 30 and the transmitting element 16) into alignment.

Further, the complementary first and second locating features 164, 166 may provide a holding force to maintain the alignment between the receiving element 30 and the transmitting element 16. In various aspects, the first and second locating features 164, 166 may be mating magnets. In additional or alternative examples, the first locating feature 164 may be a magnet and the second locating feature 166 may be a plate or component with magnetic properties. The first and second locating features 164, 166 may assist in providing initial alignment to form the charging interface 162 and retain the alignment for continual power transfer. The first and second locating features 164, 166 may also be used when the transmitting element 16 is coupled to the mattress 18 without departing from the teachings herein.

The storage feature 160 of the receiving assembly 28 is generally smaller than a battery. In various examples, the storage feature 160 is a supercapacitor. The small size of the storage feature 160 is advantageous for reducing interface pressure on the patient and not substantially disrupting an airflow path within the MCM system 138. An energy or charge level with the storage feature 160 may be continually refreshed by the power transferred through the charging interface 162 (e.g., the active power transfer). The storage feature 160 allows ratcheting up of available energy, as power can be transferred on time-varying electromagnetic conditions. Depending on what component or accessory the receiving assembly 28 is powering, the component being charged may operate in a low energy state with intermittent high energy states. The storage feature 160 may provide energy for the different operating states.

With reference still to FIGS. 5-10, the receiving assembly 28 powers various configurations of the sensor assembly 24, which utilizes the sensor 26 to sense information relevant to the care and treatment of the patient. The sensor assembly 24 is generally configured to be powered by the receiving assembly 28 and communicate data wirelessly through a wireless data transfer, as described further herein. The sensor assembly 24 may be configured to operate in a low energy state when off or when sensing data and a high energy state when wirelessly transferring data. The wireless sensor assembly 24 provides increased flexibility to the caregiver in obtaining data about the patient, as well as minimizes wires and other features that may contribute to the development of a pressure injury on the patient. The wireless sensor assembly 24 may also increase the accuracy of sensed information.

The sensor assembly 24 is powered through communication with the receiving assembly 28. The amount of power that is transferred to the receiving element 30 to power the sensor assembly 24 may be small enough that poor coupling between the receiving element 30 and the transmitting element 16 may be tolerated. Poor coupling may be caused by, for example, greater distance between the receiving element 30 and the transmitting element 16 or patient movement.

While positioned on the patient support apparatus 10, a variety of information may be obtained about the patient and the mattress 18 via the sensor assembly 24. The sensor assembly 24 may be coupled to the mattress 18 (see FIGS. 5-10). The sensor assembly 24 may include a single sensor 26 or multiple sensors 26. In configurations with multiple sensors 26, each sensor 26 may be configured to detect the same information, or alternatively, the sensors 26 may be configured to detect different information. In one non-limiting example, the sensor assembly 24 coupled to the mattress 18 may include at least one of a biometric sensor 180, a bladder pressure sensor 182, and an identification sensor 184, which may collectively be referred to herein as the sensors 26. Additional sensors 26 may be associated with the mattress 18 and/or the MCM system 138 to sense different or additional information without departing from the teachings herein.

With further reference to FIGS. 6 and 7, in the illustrated example, the sensor assembly 24 includes a health monitoring system such as the biometric sensor 180 coupled to the top ticking 86 of the mattress 18. In certain aspects, the biometric sensor 180 may be printed onto the top ticking 86. The biometric sensor 180 is in communication with the receiving assembly 28 to be powered. The biometric sensor 180 is configured to obtain biometric data from the patient. The biometric data may include various physiological parameters, for example, heart rate, respiration rate, glucose, blood pressure, and other physiological attributes of the patient. The biometric data may be wirelessly communicated to the controller 22, as discussed further herein.

In the illustrated example of FIG. 6, the biometric sensor 180 is coupled to a top surface 146 of the top ticking 86 that engages the patient. When the biometric sensor 180 is coupled to the top surface 146 of the top ticking 86, it allows the biometric sensor 180 to be in closer proximity to, or in contact with, the patient on the mattress 80 to obtain the biometric data. The receiving assembly 28 is coupled to a bottom surface 148 of the top ticking 86 to be within the predefined distance of the transmitting element 16 coupled to the support surface 14 of the upper frame 44. The biometric sensor 180 is operably coupled with the receiving assembly 28, which may generally be via wiring that extends through the top ticking 86. Therefore, when the mattress 18 is positioned on the upper frame 44, the receiving element 30 is aligned with the transmitting element 16, the charging interface 162 is formed, and the biometric sensor 180 is powered. It is also contemplated that the biometric sensor 180 may be coupled to the coverlet 142 of the MCM system 138 without departing from the teachings herein.

In the illustrated example of FIG. 7, the transmitting element 16 is coupled to an inner surface of the siderail 58. When the transmitting element 16 is coupled to the siderail 58, the receiving element 30 may be coupled to the top surface 146 of the top ticking 86 proximate to the biometric sensor 180. This configuration may reduce wiring that extends through the top ticking 86. The positioning of the biometric sensor 180, the transmitting element 16, and the receiving assembly 28 are merely exemplary and not meant to be limiting. The receiving assembly 28 may be positioned in any practicable location that forms the charging interface 162 with the transmitting element 16. Depending on the configuration of the charging system 158 and the component to be powered, the transmitting element 16 may be coupled to the support surface 14, the headboard 54, the footboard 56, or at least one of the siderails 58, 60, 62, 64.

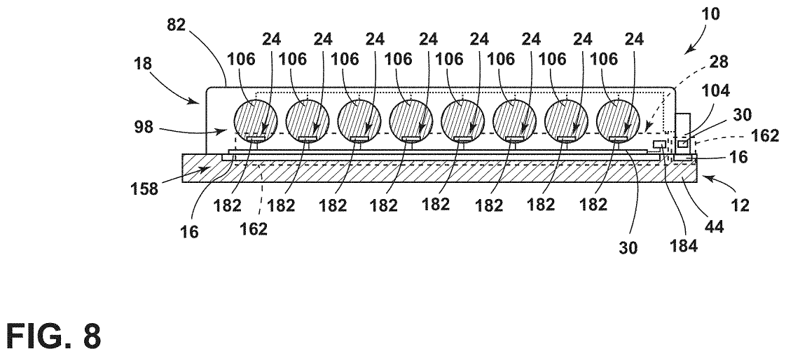

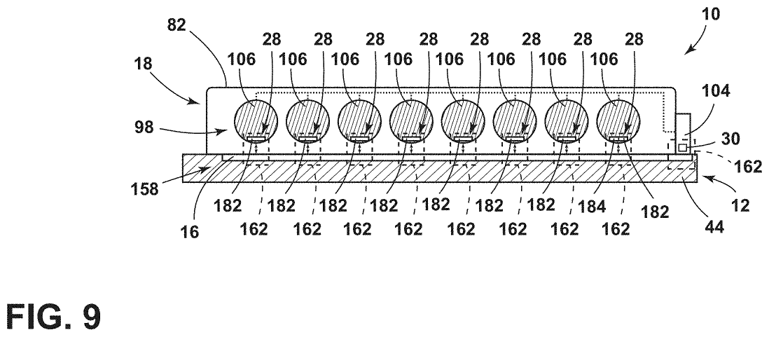

With reference again to FIGS. 8 and 9, the sensor assembly 24 may include the bladder pressure sensors 182 configured to detect pressure data from within the bladders 106 of the pneumatic system 98. The bladder pressure sensors 182 may be coupled to or disposed within the bladders 106 to obtain the pressure data. The transmitting element 16 is illustrated as a single element associated with each bladder 106, that extends across the support surface 14. It is contemplated that multiple transmitting elements 16 may be included without departing from the teachings herein.

In the illustrated example of FIG. 8, a single receiving element 30 is disposed proximate to a bottom of the mattress 18. The receiving element 30 may power some or all of the bladder pressure sensors 182. In such examples, wiring may extend from the receiving assembly 28 to each bladder pressure sensor 182.

In the example illustrated in FIG. 9, each bladder 106 may include the receiving assembly 28 associated with the corresponding bladder pressure sensor 182. In such examples, wiring to power the bladder pressure sensors 182 may be reduced compared to the illustrated example of FIG. 8. Each bladder pressure sensor 182 may be powered by a corresponding receiving assembly 28 that selectively interacts with the transmitting element 16.

Referring still to FIGS. 8 and 9, each bladder pressure sensor 182 is configured to transmit data wirelessly, as described further herein. Use of the wireless sensor assemblies 24 reduces sense line tubes within the mattress 18, offering more space for other features. Further, reducing or removing sense lines within the mattress 18 reduces the possibility of a kinked sense line, which could measure the wrong pressure. Therefore, utilizing wireless sensor assemblies 24 with the pneumatic system 98 may provide increased accuracy in sensing the pressure data.

The charging system 158 may also be utilized to power other electronic components of the mattress 82, such as the pump 104. The pump 104 may be in communication with the receiving assembly 28 associated with the bladders 106, or alternatively may include a separate receiving assembly 28. The receiving assembly 28 selectively interacts with the transmitting element 16 to provide power to the pump 104, which allows the pump 104 to adjust the bladders 106 of the pneumatic system 98. The pump 104 may operate in a lower energy state when off or idle and a high energy state when adjusting the fluid in the bladders 106. The size and number of transmitting elements 16 in the charging system 158 may depend on the location, size, and number of components to be powered.

Additionally or alternatively, the sensor assembly 24 may also include an identification sensor 184 that senses information about the mattress 18, such as a type of mattress 18. For example, the sensor assembly 24 exemplified in FIGS. 6 and 7 may sense that the mattress 18 is the non-powered mattress 80. In the example in FIGS. 8 and 9, the identification sensor 184 may sense that the mattress 18 is the powered mattress 82 that has the pneumatic system 98.

The identification data may affect the function of the patient support apparatus 10, the charging system 158, or a combination thereof. In certain aspects, the type of component to be powered may determine how much power is transferred through the charging interface 162. For example, when the sensor assembly 24 is coupled to the non-powered mattress 80, power is transferred to power the sensor assembly 24. In another example, when the powered mattress 82 is utilized, the charging system 158 transfers power to power the sensor assembly 24 and the pump 104. Powering the pump 104 generally utilizes a greater amount of power from the charging system 158 compared to the sensor assembly 24.

Additional sensors 26 may be included in the sensor assembly 24 within or coupled to the mattress 18. For example, the sensor 26 may be configured as a humidity sensor to sense humidity within or proximate to the mattress 18. In another non-limiting example, the sensor 26 may be configured as a temperature sensor to sense temperature data within or proximate to the mattress 18. Further, the sensor 26 may sense airflow within the mattress 18 or within the pneumatic system 98. The sensors 26 may be configured to obtain any practicable data helpful for caring for the patient.

With reference again to FIG. 10, the charging system 158 may also be utilized to power the blower 140 of the MCM system 138. The blower 140 may be coupled with the receiving assembly 28 to receive power similar to the pump 104 of the pneumatic system 98. Further, the identification sensor 184 may be configured to sense when the MCM system 138 is utilized rather than the pneumatic system 98. The blower 140 associated with the MCM system 138 is generally smaller than the pump 104 associated with the pneumatic system 98, thereby utilizing less power. The charging system 158 may then transfer less power when the blower 140 is being powered compared to when the pump 104 is being powered.

The sensor assembly 24 may also be disposed in, or otherwise coupled to, the MCM system 138. For example, the sensor 26 may be configured to sense temperature and/or humidity of airflow within the MCM system 138. In another example, the sensor 26 may be an airflow sensor configured to sense a strength of the airflow through the MCM system 138. Additionally or alternatively, the sensor 26 may be configured to sense air pressure within the MCM system 138. The sensor 26 may be configured to sense any practicable information helpful for caring for the patient.

The transmitting elements 16 may be selectively energized to reduce the electromagnetic fields generated proximate to the patient. Moreover, charging the sensor 26 may be performed at a lower energy level compared to charging the pump 104 or the blower 140. Use of lower energy levels and selectively energized transmitting elements 16 may advantageous to reduce or prevent interference with implanted devices of the patient (e.g., a defibrillator, etc.).

In the illustrated configuration, the mattress 18 is electrically coupled to the patient support apparatus 10, which allows energy from the power source 178 to be provided to the mattress 18 through the patient support apparatus 10. The power supplied from the power source 178 powers the transmitting elements 16 in the mattress 18. It is contemplated that the mattress 18 may be a standalone unit configured to directly engage the power source 178 without departing from the teachings herein.

Additionally or alternatively, at least one of the patient support apparatus 10 and the mattress 18 may include a force sensor for monitoring a position of the patient on the mattress 18. A transmission unit may utilize position information received from the force sensor to adjust which transmitting elements 16 are selectively energized. Accordingly, various “hot spots” of energized transmitting elements 16 may be created by the transmission unit to power the sensor assembly 24. It is contemplated that the transmitting elements 16 may also be coupled to a top surface of the MCM system 138 and function in a similar manner as described with respect to the mattress 18, without departing from the teachings herein.

With reference again to FIGS. 5-10, in examples where the sensors 26 are powered, each sensor 26 may be activated at predetermined intervals to reduce power consumption and, consequently reduce electromagnetic fields used to power the sensors 26. For example, at each interval, the sensor 26 may receive power supplied from the transmitting element 16, sense or measure the respective data, transfer the data as described further herein, and return to a deactivated or sleep state. The predefined intervals may be any practicable interval and may be adjusted by the caregiver.

Another use for the wireless transfer of power is to provide power to the siderails 58, 60 on the patient support apparatus 10. Traditionally, the siderails 58, 60 on the patient support apparatus 10 are a wired function, and power and data is transferred by wires to the siderails 58, 60 and the devices inside the siderails 58, 60, such as displays, switches, light-emitting diode (LED) indicators, and charging ports for patient owned devices. However, wireless coupling between the siderails 58, 60 and the patient support apparatus 10 for both power and data can be utilized to make the siderails 58, 60 more robust and reliable due to the elimination of cabling and wires which must flex as the siderails 58, 60 are raised and lowered.

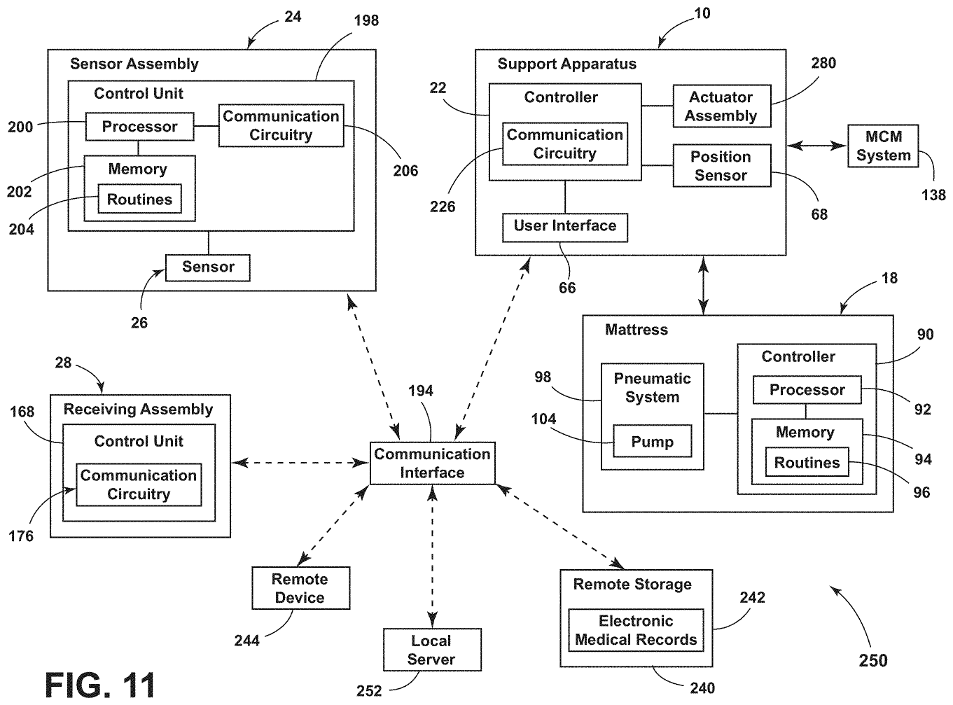

With further reference to FIGS. 5 and 11, the powering of the various components described herein may be adjusted based on communication between the controller 22 of the patient support apparatus 10 and the receiving assembly 28. Data may be communicated between the control unit 168 and the controller 22 via the charging interface 162 and/or a secondary communication link that is powered by the charging system 158 (e.g., over a wireless communication interface 194). The data transfer between the receiving assembly 28 and the controller 22 may be advantageous for adjusting the power transferred between the transmitting element 16 and the receiving element 30.

A magnitude of electromagnetic fields or waves generated between the receiving element 30 and the transmitting element 16 may be controlled or modulated by at least one of the control unit 168 and the controller 22. The electromagnetic waves may be modulated in response to the sensed coupling coefficient. At least one of the control unit 168 and the controller 22 may determine the coupling coefficient (e.g., the strength of the interaction) between the receiving element 30 and the transmitting element 16. The modulation may occur through direct communication within the charging system 158, or through the secondary communication link that is powered by the charging system 158 (e.g., the communication interface 194).

The electromagnetic field may be adjusted until at least one of a minimum exposure level and a minimum energy storage level is reached. Modulation of the electromagnetic waves may minimize exposure of the patient to the electromagnetic waves. The inclusion of the storage feature 160 in the receiving assembly 28 reduces the magnitude of the energy in the power transfer at expense of up-time availability for the various components being powered. The exposure of the patient to the electromagnetic waves is generally minimized, such that pacemakers and other implanted devices are not substantially impacted by the charging system 158. The electromagnetic waves may also be modulated to provide sufficient energy to the receiving element 30 based on the coupling coefficient to provide a minimum amount of power to support the operation of the corresponding component. For example, the electromagnetic waves may be increased when a poor coupling coefficient is detected. It is contemplated that the amount of energy utilized to power certain components may determine how often the powered component may be activated.

Additionally or alternatively, the control unit 168 may monitor power transfer information and communicate the power transfer information to the controller 22. The power transfer information may include the coupling coefficient or an amount of energy being received at the receiving element 30, which may be a sensed voltage level. The control unit 168 may monitor the voltage level and communicate the voltage level to the controller 22. The control unit 168 may store a predefined voltage level to be received for powering the various components. The predefined voltage may differ based on what component is being powered (e.g., the sensor assembly 24 compared to the pump 104, etc.).

If the voltage being received by the receiving assembly 28 is below the predefined voltage level, the controller 22 may respond by increasing an intensity of the transmitting element 16 to generate more energy. In such circumstances, a greater loss of power may occur but the receiving assembly 28 may receive sufficient energy to power the various components. If the voltage received by the receiving assembly 28 is above the predefined level, the intensity of the transmitting element 16 may be reduced to minimize energy loss. In this way, the charging system 158 is adaptive based on the coupling between the transmitting element 16 and the receiving element 30.

Referring still to FIGS. 5 and 11, the control unit 168 is communicatively coupled to the storage feature 160 and may determine a current energy or charge level. The control unit 168 may compare the current energy level to a predefined energy threshold or predefined charge level. When the current energy level stored in the storage feature 160 reaches the predefined energy threshold, the sensor assembly 24 may initiate the wireless data transfer as described herein. At least one of the controller 22 and the control unit 168 may control the power and data transfer between the receiving assembly 28 and the patient support apparatus 10 or the mattress 18 in response to the coupling coefficient. One or both of the power transfer and the data transfer may be conducted over varying time intervals controlled by the local coupling coefficient based on alignment between the transmitting element 16 and the receiving element 30. When the coupling coefficient reaches a predefined level, the power transfer and the data transfer may be started. Alternatively, the power transfer may start at a first predefined level, and the data transfer may start at a second predefined level.

With reference still to FIG. 11, as previously stated, the various configurations of the sensor assembly 24 are each configured to wirelessly transmit sensed data. The wireless transmission of data reduces wiring in components used to care for the patient, which may assist to reduce pressure injury development. The wireless transmission of data is also advantageous to communicate information about the patient or treatment for the patient to the caregiver.

The sensor assembly 24 includes the sensor 26 in communication with a control unit 198. The sensor 26 may be configured as any one or more of the biometric sensor 180, the bladder pressure sensor 182, the identification sensor 184, and an interface pressure sensor. The control unit 198 includes a processor 200, a memory 202, and other control circuitry. Instructions or routines 204 are stored within the memory 202 and are executable by the processor 200. The control circuitry includes communication circuitry 206 that communicates with the controller 22 of the patient support apparatus 10. The control unit 198 receives the sensed data from the various sensors 26 and communicates the sensed data to the controller 22 of the patient support apparatus 10 via the communication interface 194.

The controller 22 of the support apparatus is communicatively coupled with the control unit 198 of the sensor assembly 24. The controller 22 has a processor 220, a memory 222, and other control circuitry. Instructions or routines 224 are stored within the memory 222 and are executable by the processor 220. The control circuitry includes communication circuitry 226 to communicate via the communication interface 194. In various examples, the controller 22 receives the sensed data from the sensor assembly 24 and may adjust the patient support apparatus 10 or the charging system 158 in response to the sensed data.

Additionally, one or both of the control unit 198 of the sensor assembly 24 and the controller 22 of the patient support apparatus 10 may communicate the sensed data to at least one of an electronic medical record (EMR) 240 stored in a remote server 242 and a remote device 244 that can be viewed by the caregiver. The sensed information may be communicated to an information system 250 to be viewed by the caregiver treating the patient. It is contemplated that other types of sensors 26 may be utilized within the charging system 158 without departing from the teachings herein.

According to various aspects, the biometric sensor 180 may monitor various physiological attributes (e.g., the biometric data) of the patient, including, for example, heart rate, respiration rate, blood pressure, and glucose. The biometric data may be monitored by the caregiver, which allows the caregiver to monitor the status of the patient and provide treatments in response. The biometric data may be communicated to the controller 22 and subsequently stored in the EMR 240 and/or viewed on the application interface. Further, the biometric data may be utilized to trigger various alerts when the biometric data is outside of a predefined range or a change in the biometric data is outside a predefined change range.

Based on the sensed biometric data, the patient support apparatus 10 may be adjusted to a certain position (e.g., elevated head region, etc.). The caregiver may adjust the patient support apparatus 10, or alternatively, the patient support apparatus 10 may automatically adjust to a predefined position based on the sensed data. The patient support apparatus 10 includes an actuation assembly 280, which may adjust the upper frame 44 relative to the base frame 46 and/or the segments 48, 50, 52 of the upper frame 44 relative to one another.

Referring still to FIG. 11, the sensor assembly 24 with the bladder pressure sensors 182 associated with the pneumatic system 98 may provide more accurate information for determining pressure to be utilized for various pressure therapies. For example, when the pneumatic system 98 is activated by the caregiver, the bladders 106 may be independently adjusted between the deployed and non-deployed state. The bladder pressure sensors 182 may continually sense the pressure within the bladders 106 and the sensed pressure data may be communicated to the controller 22 of the patient support apparatus 10. The patient support apparatus 10 may adjust the position of the frame 12 to maximize the pressure therapy.

Further, the caregiver may monitor the condition of the patient in response to an inflation level of the bladders 106 separate from and during therapies. The caregiver may adjust the amount of fluid within the bladders 106 to provide greater comfort to the patient or to adjust the pressure applied via the therapies. The sensed pressure and change in sensed pressure may be monitored by the caregiver to determine the effectiveness of the selected pressure therapy. Additionally or alternatively, the sensed pressure information may be communicated to the remote server 242 and stored within the EMR 240.

With further reference still to FIG. 11, the interface pressure sensor may be utilized to monitor the potential development of pressure injuries by sensing pressure applied to certain body regions. For example, when the patient support apparatus 10 has an elevated head region, for example, a 30° elevation, weight is shifted to a hip or pelvis area of the patient, which may contribute to pressure injury development. A pressure injury is localized damage to the skin and underlying soft tissue. Generally, the pressure injury is developed over a bony prominence and may be related to the use of a medical or treatment device. Pressure injuries can develop as a result of intense pressure, prolonged pressure, pressure in combination with shear, or a combination thereof. The sensor assembly 24 may sense a magnitude of the pressure on a specific region of the patient, for example, the sacral region, as well as a duration of the pressure.

The sensed pressure may be communicated to the controller 22. In response to the sensed pressure data, the controller 22 of the patient support apparatus 10 may activate the actuation assembly 280 to adjust the position of the upper frame 44 to reduce pressure on certain body areas. Additionally or alternatively, the controller 22 may communicate with the mattress 18 to activate the pneumatic system 98 in accordance with information from the EMRs 240 (e.g., stored pressure therapies). The controller 22 may also generate an alert that the patient may be at risk for developing a pressure injury.

Additionally or alternatively, the identification data sensed by the identification sensor 184 may be utilized to control the function of the patient support apparatus 10. For example, when the non-powered mattress 80 is utilized, the patient support apparatus 10 may have a greater range of articulation between the segments 48, 50, 52 of the upper frame 44. If the powered mattress 82 then replaces the non-powered mattress 80, the patient support apparatus 10 may adjust the position of the upper frame 44 to a shallower incline, for example, to maximize the effect of the bladders 106 in the pneumatic system 98.

Further, the position information from the patient support apparatus 10 may affect the function of the mattress 18. For example, if the head region is elevated, turn assist protocols may not be activated in the mattress 18, as turning the patient in the elevated head position may result in discomfort to the patient or less effective results. Accordingly, the identification information from the sensor assembly 24 may alter functions of the patient support apparatus 10 and/or the mattress 18.

Referring still to FIG. 11, as previously stated, the data communication between various devices may be conducted via the communication interface 194. The communication interface 194 may be part of a network of the medical facility. The network may include a combination of wired connections, as well as wireless connections, which may include the communication interface 194. The communication interface 194 includes a variety of electronic devices, which may be a combination of various wired or wireless communication protocols. The communication interface 194 may be implemented via one or more direct or indirect nonhierarchical communication protocols, including but not limited to, Bluetooth®, Bluetooth® low energy (BLE), Thread, Ultra-Wideband, Z-wave, ZigBee, etc.

Additionally, the communication interface 194 may correspond to a centralized hierarchal communication interface 194 where one or more of the devices communicate via a router (e.g., a communication routing controller). The communication interface 194 may be implemented by a variety of communication protocols including, but not limited to, global system for mobile communication (GSM), general packet radio services, code division multiple access, enhanced data GSM environment, fourth generation (4G) wireless, fifth generation (5G) wireless, Wi-Fi, world interoperability for wired microwave access (WiMAX), local area network, Ethernet 262, etc. By flexibly implementing the communication interface 194, various devices and servers may communicate with one another directly via the wireless communication interface 194 or a cellular data connection.

The controllers and control units disclosed herein may include various types of control circuitry, digital or analog, and may each include the processor, a microcontroller, an application specific circuit (ASIC), or other circuitry configured to perform the various input or output, control, analysis, or other functions described herein. The memories described herein may be implemented in a variety of volatile and nonvolatile memory formats. Routines include operating instructions to enable various methods described herein.

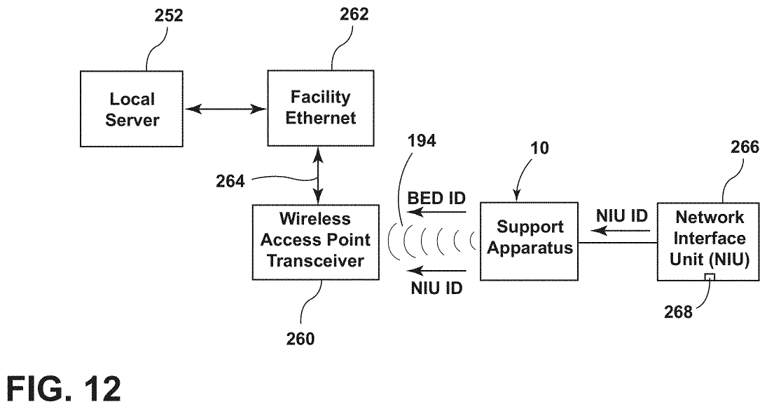

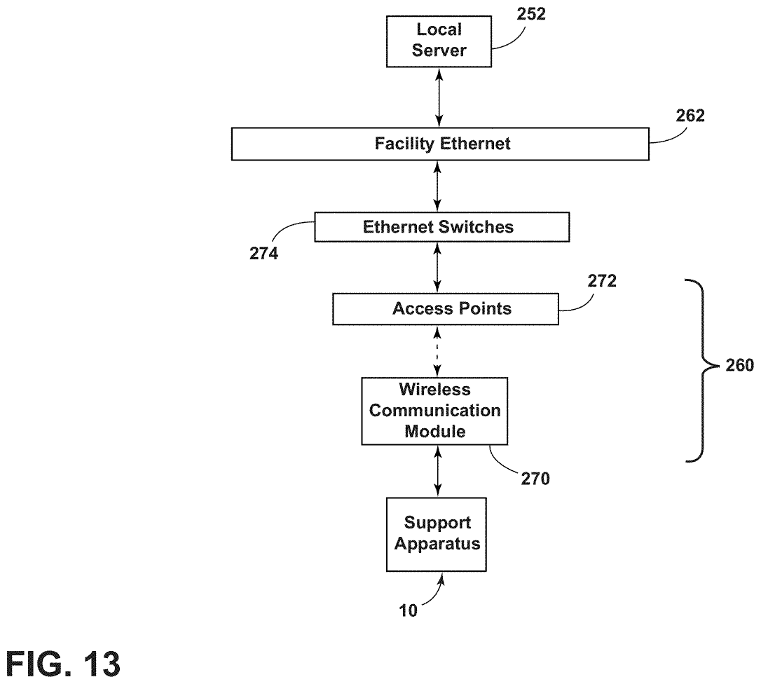

With reference still to FIG. 11, as well as FIGS. 12 and 13, the patient support apparatus 10 is configured to communicate data, which may include the sensed data from the sensor assembly 24, to the information system 250 of the medical facility. A local server 252 may include software related to the information system 250. The remote device 244 and the remote server 242 may also be in communication with the information system 250 to receive the information from the patient support apparatus 10 and send additional information.

Exemplary communications of the patient support apparatus 10 to the information system 250 are illustrated. In certain aspects, the patient support apparatus 10 is configured to communicate with a wireless access transceiver 260, which is coupled to Ethernet 262 of the medical facility, the communication interface 194 provides for bidirectional communication between the patient support apparatus 10 and a wireless access transceiver 260. The wireless access transceiver 260 communicates directly with the Ethernet 262 via a data link 264.

As illustrated in FIG. 12, the patient support apparatus 10 may be associated with a network interface unit 266. Multiple network interface units 266 may be provided in various locations of the medical facility. The patient support apparatus 10 and the network interface units 266 are each assigned a unique identification code, such as a serial number. The local server 252, or another aspect of the information system 250, may include software that operates to associate the identification code of the patient support apparatus 10 with identification data of the network interface unit 266 to locate the patient support apparatus 10 within the medical facility. Each network interface unit 266 includes a port 268 for selectively coupling with the Ethernet 262. When the network interface unit 266 is coupled with the Ethernet 262, the network interface unit 266 communicates the identification data to the patient support apparatus 10, which then wirelessly communicates the data for the patient support apparatus 10 and the network interface unit 266 to the wireless access transceiver 260. The wireless access transceiver 260 then communicates with the local server 252 via the Ethernet 262.

As illustrated in FIG. 13, the patient support apparatus 10 may be capable of communicating wirelessly via a wireless communication module 270. The wireless communication module 270 generally communicates via a Serial Peripheral Interface (SPI) link with circuitry of the associated patient support apparatus 10 (e.g., the communication circuitry 226) and via wireless a wireless 802.11 link with wireless access points 272. The wireless access points 272 are generally coupled to Ethernet switches 274 via 802.3 links. It is contemplated that the wireless communication modules 270 may communicate with the wireless access points 272 via any of the wireless protocols described herein. Additionally or alternatively, the Ethernet switches 274 generally communicate with the Ethernet 262 via 802.3 links. The Ethernet 262 is also engaged with the local server 252, allowing information to be communicated between the local server 252 and the patient support apparatus 10.

Referring again to FIG. 11, the patient support apparatus 10 is generally in communication with the remote device 244. The remote device 244 includes an application or software for displaying the application interface. The remote device 244 may be a phone, a tablet, a wearable device, a laptop, or other devices. The remote device 244 may be associated with the information system 250 for sharing information and communicating information between caregivers. The application interface may display information from the EMR 240, the sensor assembly 24, the patient support apparatus 10, the charging system 158, or a combination thereof.

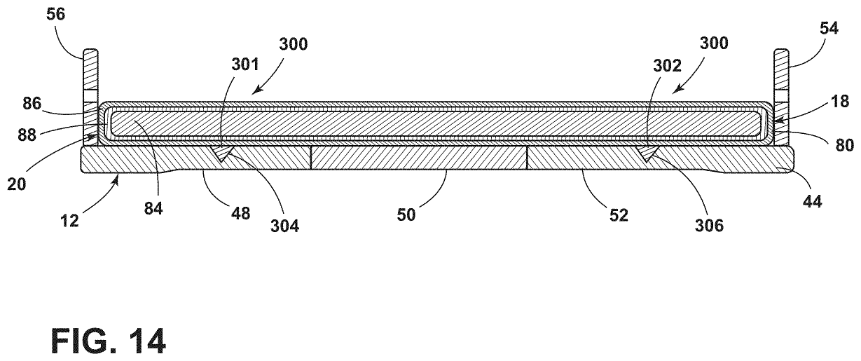

With reference now to FIG. 14, an exemplary construction is shown that illustrates a plurality of locating features 300 defined between the patient support 18 and the upper frame 44. The locating features 300 are generally configured to help a caregiver locate the patient support 18 on the bed frame 12. When supplying power to the patient support 18, or various other components or sensors of the patient support apparatus 10, proper positioning of the patient support 18 is significant. Misalignment of the patient support 18 relative to the upper frame 44 can result in minimal charging, increased charging time, or no connection at all between the receiving assembly 28 and the transmitting assembly 15, resulting in no power to the patient support 18 or other various components of the patient support apparatus 10.

As shown in FIG. 14, first and second engagement features 301, 302 are positioned at the lower segment 48 and the upper segment 52. It will be understood that more or less locating features may be positioned between the patient support 18 and the upper frame 44. As shown, the engagement features 301, 302 of the patient support 18 include a pyramidal or possibly conical configuration. At the same time, retention or receiving features 304, 306, which are in the form of apertures, of the upper frame 44 have a complementary pyramidal or conical configuration designed to receive the engagement features 301, 302 of the patient support 18. The engagement features 301, 302 of the patient support 18 may be constructed from a hard plastic, such as high density polyethylene, and may even include antimicrobial layers design to maintain a safe environment and minimize bioburden. In a similar fashion, the receiving features 304, 306 also include a smooth surface constructed from a hard plastic or metal. As with the engagement features 301, 302, the receiving features 304, 306 may also be treated with an anti-microbial material. The surfaces of the receiving features 304, 306 and the engagement features 301, 302 are configured for easy cleanup and fast installation of the patient support 18 onto the bed frame 12. It will also be understood that the engagement features 301, 302 may be disposed on the bed frame 12 and the receiving features 304, 306 may be defined in a bottom surface of the patient support 18.

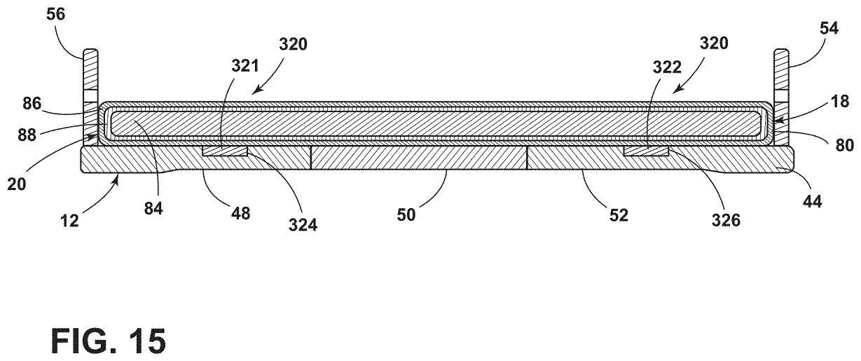

With reference now to FIG. 15, the illustrated construction includes locating features 320 that include engagement features 321, 322 that protrude into receiving features 324, 326, illustrated in the form of apertures, defined in the upper frame 44 of the patient support apparatus 10. The engagement features 321, 322 may have rounded corners such that cleaning of both the engagement features 321, 322 and the receiving features 324, 326 by a caregiver is relatively easy. Again, the configuration of the locating features 320 is designed to provide confirmed and easy installation of the patient support 18 onto the upper frame 44. The locating features 320 provide proper alignment of the patient support 18 on the bed frame 12 to maximize the efficient flow of power from the transmitting assembly 15 to the receiving assembly 28.

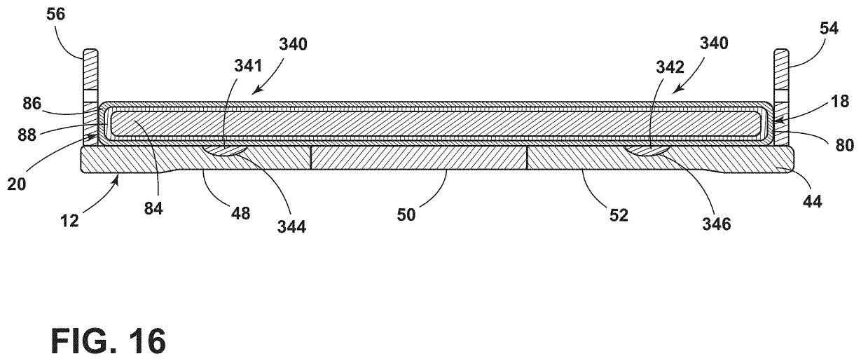

With regard to FIG. 16, another construction is illustrated that includes locating features 340 with engagement features 341, 342 that are configured to engage receiving features 344, 346, which are also shown in the form of apertures. The engagement features 341, 342 include a rounded construction that may be relatively shallow or up to and including a hemispherical construction in shape. The engagement features 341, 342 are configured to be received within the receiving features 344, 346 to properly align the receiving assembly 28 with the transmitting assembly 15 to maximize the efficient flow of power from the transmitting assembly 15 to the receiving assembly 28.

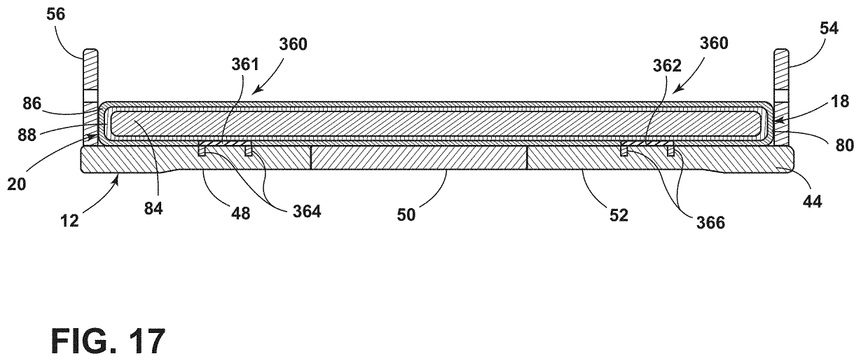

With reference now to FIG. 17, yet another construction illustrates locating features 360 defined within the patient support 18. The locating features 360 include magnetic members 361, 362 that have magnets, a magnetized material, or a magnetizable material configured to interact with complementary receiving features 364, 366 disposed within, and possibly embedded within, the upper frame 44 of the patient support apparatus 10. It is generally contemplated that the receiving features 364, 366 may include magnets that are attracted to the magnetic members 361, 362. Conversely, it is also contemplated that the receiving features 364, 366 may include magnets that oppose or repel the magnetic members 361, 362. The magnets may include any of neodymium magnets that include a disc, rod, plate, cube, ring, cylinder, or spherical construction. The magnets may also include a cup-type configuration. It is generally contemplated that the magnet will include a general strong magnetic field capable of attracting another magnet, or iron, steel, nickel, cobalt, etc. In addition, it is contemplated that the magnet may be a permanent magnet that maintains a magnetized field for an extended period of time. In an exemplary construction, a magnet having a north pole facing upward on the upper frame 44 of the patient support apparatus 10 will be aligned with a magnet having a south pole facing downward on a bottom surface of the patient support 18. It is contemplated that both the magnet within the patient support 18 and the magnet within the upper frame 44 of the patient support apparatus 10 will be embedded within their respective structures. Upon proper alignment of the patient support 18 on the patient support apparatus 10, and specifically, on the upper frame 44, the magnets will attract and maintain proper alignment of the patient support 18 on the bed frame 12. In so doing, proper alignment of the receiving assembly 28 and the transmitting assembly 15 is maintained such that effective communication, and consequently, effective power transfer can occur between the transmitting assembly 15 and the receiving assembly 28.

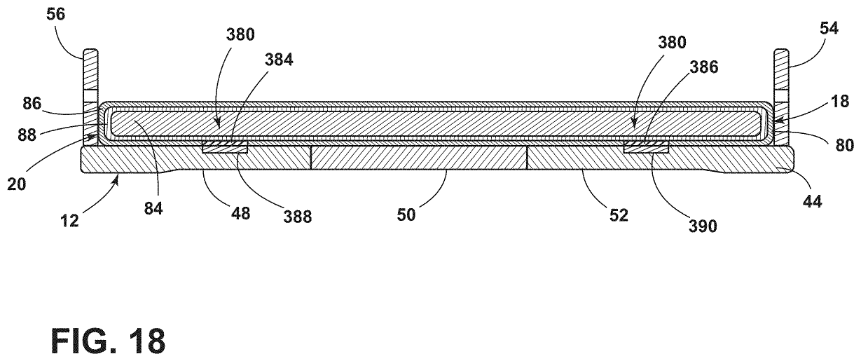

With reference now to FIG. 18, the illustrated construction includes locating features 380 that have patient support couplers 384, 386 in the form of embedded magnetic members disposed within the patient support 18 and frame couplers 388, 390 in the form of embedded magnetic members disposed within the upper frame 44. The patient support couplers 384, 386 may include a magnet or metallic material that is attracted to another magnet or magnetic material. Similarly, the frame couplers 388, 390 may be a magnet or metallic material that may be attracted to a magnet. Regardless, the locating features 380 are designed to properly align the patient support 18 on the upper frame 44 of the patient support apparatus 10.

With any of the configurations discussed above with regard to FIGS. 14-18, it is generally contemplated that additional components may be provided that aid in both connecting the patient support 18 with the upper frame 44 and maintaining that connection. For example, the configuration shown in FIGS. 14 and 15 may include a snap-fit connection such that reception of the locating feature frictionally engages the receiving feature. Specifically, with regard to FIG. 14, slight detents might be located along a wall of each of the engagement features 301, 302. These detents may be configured to engage a complementary feature defined in the upper frame 44. These features would be located within the receiving features 304, 306. A similar configuration could also be provided with regard to FIG. 15. Specifically, the engagement features 321, 322 may include slight detents configured to engage complementary features within the receiving features 324, 326. The snap-fit construction allows for an audible and/or tactile feedback provided from the locating feature to the caregiver. This feedback acts as an indicator to the caregiver so that the caregiver knows the locating features have been properly aligned and engaged. Once engaged, the patient support 18 can maintain position on the upper frame 44. Additionally or alternatively, upon proper alignment of the locating features and secure engagement of the locating features thus maintaining a position of the patient support 18 with the upper frame 44, a proper connection between the transmitting assembly 15 and the receiving assembly 28 is established. Once the connection has been established, the controller may send a signal to an indicator positioned at a visible location on the patient support apparatus 10, wherein the indicator illuminates when the receiving assembly 28 and the transmitting assembly 15 are in proper communication, therefore providing a digital and/or visual indication to the caregiver as well. The indicator may be an LED light, an incandescent light, a notification on a display screen, etc.

In addition, it is contemplated that configurations such as the construction of FIG. 14 and the construction of FIG. 18 could be combined. Specifically, a protrusion may be formed on one of the patient support 18 and the upper frame 44 of the patient support apparatus 10. A recess or aperture is defined in the other of the patient support 18 and the upper frame 44 of the patient support apparatus 10. At the same time, a magnetic member is disposed in the protrusion and a complementary magnetic member is disposed beneath the surface adjacent to the aperture. Consequently, engagement of the locating feature includes both a connection of the engagement features 301, 302 with the receiving features 304, 306 and, at the same time, a magnetic connection that is established between the magnetic member disposed within the engagement features 301, 302 and the magnetic member disposed below the surface, but adjacent to the receiving features 304, 306. This configuration is also conceived for the construction shown in FIGS. 15 and 16. Each of these configurations would have a male-female connection and at the same time a magnetic connection that is established between the patient support 18 and the upper frame 44 of the bed frame 12.

It should also be noted that the locating features set forth herein may include generally smooth surfaces through which at least one of data and power are transferred from the transmitting assembly 15 to the receiving assembly 28. More specifically, as illustrated in FIGS. 14 and 18, for example, the transmitting assembly 15 in each instance may include a transmitting planar surface and the receiving assembly 28 may include a receiving planar surface that is in abutting contact with the transmitting planar surface. As a result, at least one of data and power can be transferred through the transmitting planar surface to the receiving planar surface. As set forth herein, these planar surfaces are generally free of cracks and crevices that can collect bacteria and debris. Further, the planar surfaces provide an easy to clean area that has a low bioburden.

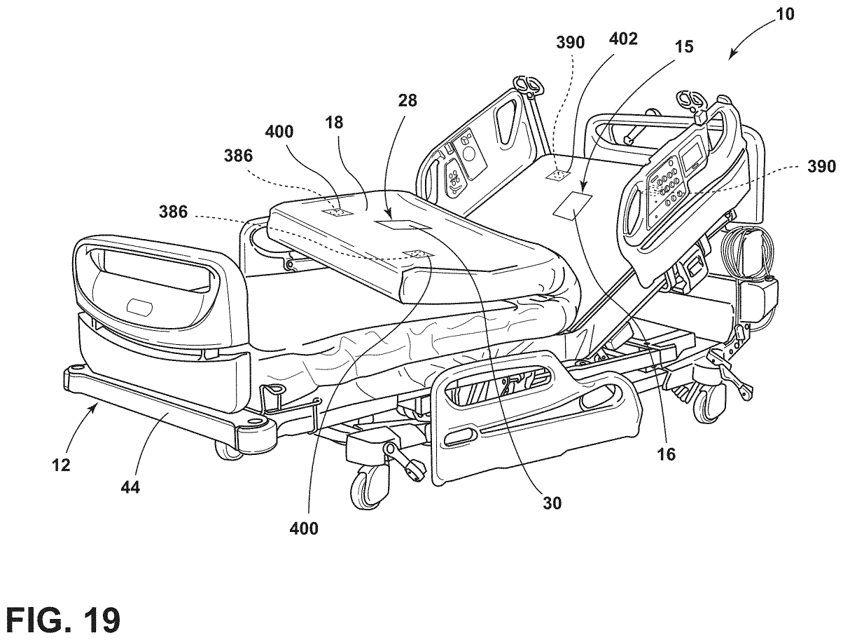

With regard to FIG. 19, the illustrated configuration shows the frame couplers 390 that have magnetic qualities and embedded within the patient support apparatus 10. A square indicia 402 is positioned about each of the frame couplers 390 so that a caregiver can readily identify the position of the frame couplers 390 for proper alignment when engaging the frame couplers 390 with the patient support couplers 386 that are embedded within the patient support 18. Likewise, a square indicia 400 is disposed about each of the patient support couplers 386 to aid in aligning the frame couplers 390 with the patient support couplers 386. Once the frame couplers 390 are engaged with the patient support couplers 386, the transmitting assembly 15 will be aligned with the receiving assembly 28. It is generally contemplated that the magnetic qualities of the frame couplers 390 and patient support couplers 386 will be sufficiently strong to maintain the patient support 18 in position on the patient support apparatus 10.

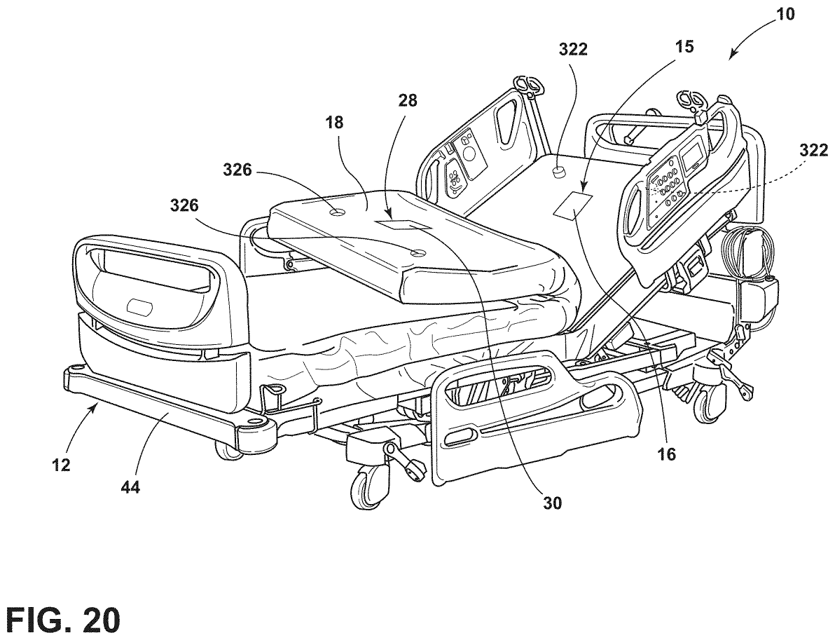

As illustrated in FIG. 20, the configurations generally shown in FIG. 15 are shown on the patient support apparatus 10. Notably, the engagement features 322 are positioned on the upper frame 44 of the frame 12 in FIG. 20. In FIG. 15, the engagement features 322 are located on a bottom surface of the patient support 18. As previously noted, it is generally conceived that the engagement features of any of these embodiments may be positioned on the bottom surface of the patient support 18 or on the top surface of the upper frame 44. Conversely, the receiving features or receiving apertures, as set forth herein, may be located on either the bottom surface of the patient support 18 or a top surface of the upper frame 44 of the frame 12, depending on the intended use.

Once the engagement features 322 are aligned with the receiving features 326, and engaged therewith, the transmitting assembly 15 will be aligned with the receiving assembly 28 and the transmitting element 16 will be in close proximity to or abutting the receiving element 30 thereby establishing a secure communication between the transmitting element 16 and the receiving element 30.

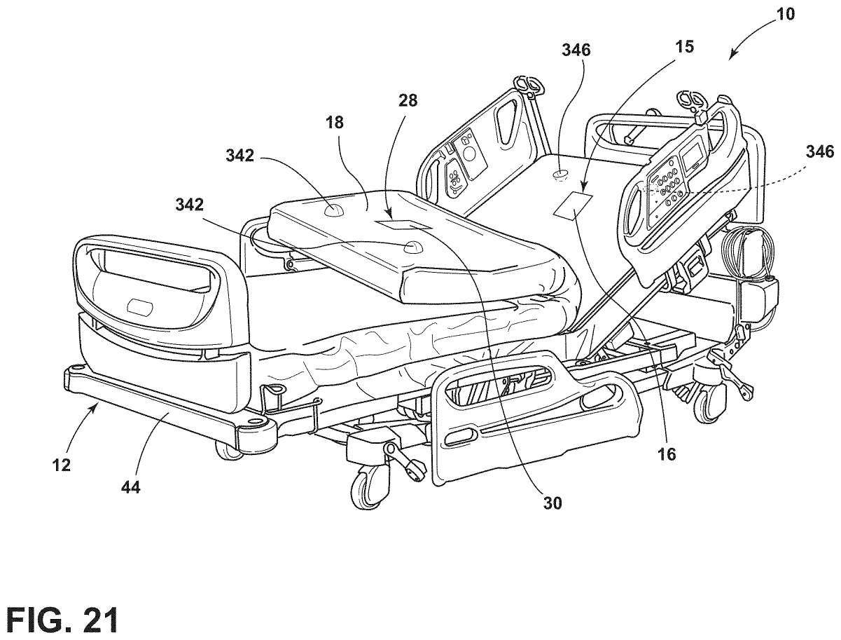

Turning now to FIG. 21, the illustrated patient support apparatus 10 includes hemispherical engagement features 342 disposed on a bottom surface of the patient support 18. As with the previously discussed configurations, when the engagement features 342 are aligned with and engage the complementary receiving features 346, which are in the form of receiving apertures, the transmitting assembly 15 will be aligned with the receiving assembly 28 such that power can be conveyed from the transmitting element 16 to the receiving element 30 to power features of the patient support 18 as well as other components of the patient support apparatus 10.

Therapeutic hospital bed mattresses and support surfaces can be very important for individuals with complex medical conditions or individuals looking for optimal comfort and luxury from their mattresses. When a patient becomes bedbound or immobile, the skin on major pressure points of the patient's body can begin to breakdown. This breakdown can lead to pressure sores. Patients who have thin, frail skin are particularly prone to developing pressure sores. In these instances, introduction of a mattress replacement system, such as the one set forth herein, may be appropriate.

In some cases, a patient's weight, frame status (such as head of bed status), frame orientation, side rail position, etc. are not available. As a result, a mattress replacement system is not optimized to provide a given patient ideal therapy or comfort. Consequently, some advanced functions, which are normally available with the mattress replacement system are not available. For example, turn assist functionality, continuous lateral rotation therapy, and percussion/vibration features are not generally available in this circumstance. The system as set forth herein overcomes these shortcomings.

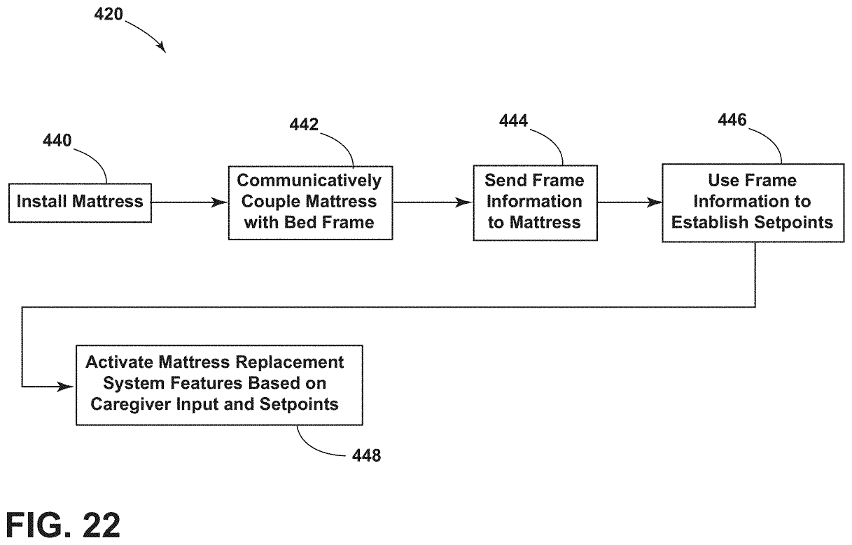

Specifically, with reference to FIG. 22, the mattress 18 (FIGS. 1-10 and 14-21), as described herein, may be part of a mattress replacement system 420. The mattress replacement system 420 is generally designed to provide the best mattress to a patient depending on a variety of factors including, but not limited to, skin condition, ailment, desired movement, comfort, etc. Setpoints can be calibrated so that the mattress replacement system 420 provides an ideal comfort and treatment level to the patient.

More specifically, with reference again to FIG. 22, the mattress 18, which may be part of the mattress replacement system 420, is installed on the frame 12 of the patient support apparatus 10 (step 440). During installation, the mattress 18 establishes communication with the frame 12 (step 442). The transmitting element 16 in the frame 18 relays frame information to the receiving element 30 of the mattress 18 of the mattress replacement system 420, in step 444. Then, in step 446, when the frame information is relayed to the mattress replacement system 420, optimum setpoints that are conducive to ideal treatment for the patient can be determined. When the optimum setpoints are determined, preferred therapies and functions are made available and activated by the mattress replacement system (step 448).

Establishing setpoints aids in providing a wide range of mattress functions such as turn assist functionality, continuous lateral rotation therapy, and percussion/vibration features with increased patient safety. This results in the support surface 14 being more technologically advanced and more effective.

It will be contemplated that the mattress 18 and the mattress replacement system 420, as set forth herein, may include additional monitoring functionality that is measured at the surface of the mattress 18. As discussed above, the mattress 18 may include one or more sensors 26, including, but not limited to, the biometric sensor 180, which is configured to obtain and relay various biometric data from a patient for monitoring by a caregiver, such as various physiological parameters of the patient, which may include, for example, heart rate, respiration rate, glucose, blood pressure, temperature, humidity, and other physiological attributes and vitals of the patient, an interface pressure sensor, which allows for the monitoring and mapping of the pressure between a patient and the support surface (ie., the mattress 18 and the mattress replacement system 420), and the bladder pressure sensor 182, which is configured to detect pressure data from within the bladders 106 of the pneumatic system 98, and may be utilized for immersion sensing. Immersion sensing capability and methods of managing bladder pressure in an occupant support and mattress is further described in U.S. Pat. No. 10,857,051, which is hereby incorporated by reference herein in its entirety. The identification sensor 184 may also be utilized in the mattress 18 and the mattress replacement system 420, and provides for additional monitoring functionality related to patient positioning and various other surface modes, functions, and additional controls associated with the patient support apparatus 10. The data collected from the various sensors 26 allows a caregiver to adjust the mattress 18, the mattress replacement system 420, and the frame 12, as well as other elements of the patient support apparatus 10, to optimize the care provided to the patient.

The MCM system 138 may also be integrated with the mattress 18 and the mattress replacement system 420, and provides for additional monitoring functionality related to temperature and humidity sensing. The MCM system 138 may include functionality for monitoring a blower speed in revolutions per minute (rpm) of the blower 140. Other additional monitoring functionality related to various surface diagnostics as well as fluid ingress detection may also be included in the mattress 18 and/or the mattress replacement system 420.

It will also be contemplated that the mattress 18 and the mattress replacement system 420 may include functionality for monitoring and controlling power supplied to the mattress 18, the mattress replacement system 420, and any other features of either the mattress 18 and the mattress replacement system 420 that require power, including those discussed herein as well as to any other mattress feature that is known in the art.

The system disclosed herein is further summarized in the following paragraphs and is further characterized by combinations of any and all of the various aspects described therein.

According to another aspect of the present disclosure, a power supply system for a facility includes a patient support apparatus with a controller and a patient support. A power source is operably coupled to the patient support apparatus. The controller is in communication with the power source. A transmitting assembly is coupled to the patient support apparatus and the power source. A receiving assembly is operably coupled to the patient support. The transmitting assembly wirelessly communicates with the receiving assembly to power the patient support. A locating feature is in communication with the controller of the patient support apparatus. The locating feature is configured to aid in aligning the power source on the patient support apparatus to indicate when the receiving assembly is in communication with the transmitting assembly.

According to another aspect of the present disclosure, a locating feature is configured to guide a receiving assembly into communication with a transmitting assembly.

According to still another aspect of the present disclosure, a locating feature includes one of an audible, tactile, and visual indication that confirms communication between a receiving assembly and a transmitting assembly.

According to another aspect of the present disclosure, a receiving assembly and a transmitting assembly are configured to communicate via capacitive coupling to charge a power source.

According to yet another aspect of the present disclosure, a locating feature includes a magnetic locating feature on one of a receiving assembly and a transmitting assembly that interacts with a complementary locating feature on the other of the receiving assembly and the transmitting assembly.

According to another aspect of the present disclosure, a locating feature includes a snap-fit connection between a receiving assembly and a transmitting assembly that locates a patient support relative to a patient support apparatus.

According to still another aspect of the present disclosure, a locating feature includes at least one protrusion on one of a patient support and a patient support apparatus and an aperture on the other of the patient support and the patient support apparatus. The protrusion is received by the aperture when a transmitting assembly and a receiving assembly are properly aligned.

According to another aspect of the present disclosure, a power supply system includes an indicator device operably coupled to at least one of a patient support apparatus, a power source, a receiving assembly, and a transmitting assembly. The indicator device illuminates when the receiving assembly and the transmitting assembly are in communication.

According to another aspect of the present disclosure, a power supply system includes an indicator device operably coupled to at least one of a patient support apparatus, a power source, a receiving assembly, and a transmitting assembly. The indicator device sends a signal to a remote device that the receiving assembly and the transmitting assembly are in communication.

According to another aspect of the present disclosure, a charging system includes a sensor operably coupled to a receiving assembly. The sensor is configured to sense at least one of an electric field, a magnetic field, and an electromagnetic field emitted by a transmitting assembly.

According to still another aspect of the present disclosure, a patient support includes at least one of a microclimate management system and a pressurization system.

According to yet another aspect of the present disclosure, a receiving assembly is completely embedded within a patient support.

According to still another aspect of the present disclosure, an interface defined between a receiving assembly and a transmitting assembly is smooth and free of any plug and receptacle power connection thereby enhancing cleanability and reducing bioburden.

According to another aspect of the present disclosure, a locating feature also defines a retention feature configured to retain a patient support in position on a frame so that a receiving assembly maintains wireless communication with a transmitting assembly.

According to another aspect of the present disclosure, a patient support apparatus powering system includes a frame, a patient support disposed on the frame, a wheel coupled to the frame and configured to engage a floor surface, and a controller. A rechargeable battery is coupled to a patient support apparatus and is in communication with the controller. A receiving assembly is coupled to the patient support and includes a locating feature that is operably coupled to the frame. The receiving assembly is in communication with the rechargeable battery. A transmitting assembly is operably coupled to the frame and includes a complementary locating feature that is configured to aid a caregiver in aligning the receiving assembly adjacent to the transmitting assembly such that the transmitting assembly is in electrical communication with the receiving assembly.

According to another aspect of the present disclosure, a rechargeable battery is configured to be recharged from a patient support apparatus powering system.

According to another aspect of the present disclosure, a locating feature includes generally smooth surfaces through which at least one of data and power are transferred from the transmitting assembly to the receiving assembly.

According to another aspect of the present disclosure, a transmitting assembly includes a transmitting planar surface and a receiving assembly includes a receiving planar surface that is in abutting contact with the transmitting planar surface. At least one of data and power are transferred through the transmitting planar surface to the receiving planar surface.

According to another aspect of the present disclosure, a patient support apparatus powering system includes an indicator device operably coupled to at least one of a patient support apparatus, a rechargeable battery, a receiving assembly, and a transmitting assembly. The indicator device illuminates when the receiving assembly and the transmitting assembly are in communication.

According to another aspect of the present disclosure, a patient support apparatus powering system includes an indicator device operably coupled to at least one of a patient support apparatus, a rechargeable battery, a receiving assembly, and a transmitting assembly. The indicator device sends a signal to a remote device that the receiving assembly and the transmitting assembly are in communication.

According to still another aspect of the present disclosure, a patient support apparatus powering system includes a health monitoring system that is operably coupled with a patient support apparatus and a rechargeable battery. The health monitoring system includes at least one physiological sensor for sensing a physiological parameter of a patient disposed on the patient support apparatus.

According to another aspect of the present disclosure, a rechargeable battery is completely embedded within a patient support.

According to yet another aspect of the present disclosure, an locating feature also defines a retention feature configured to retain a patient support in position with a frame so that a receiving assembly maintains wireless communication with a transmitting assembly.

According to another aspect of the present disclosure, a patient support apparatus includes a bed frame that has a support surface. A transmitting assembly is coupled to the bed frame. A mattress is selectively positioned on the support surface. A controller is communicatively coupled to the transmitting assembly. A sensor assembly is coupled to the mattress and is configured to sense information about at least one of the mattress and a person positioned on the mattress. A receiving assembly is embedded within the mattress and is in communication with the sensor assembly. The receiving assembly is configured to selectively interact with the transmitting assembly via one of inductive coupling and capacitive coupling to power the sensor assembly.

According to still another aspect of the present disclosure, a mattress includes a pneumatic system having a bladder operable between a deployed state and a non-deployed state.

According to still another aspect of the present disclosure, a patient support apparatus includes a locating feature that is in communication with a controller. The locating feature includes one of an audible, tactile, visual, and digital indication that confirms communication between a receiving assembly and a transmitting assembly.

According to another aspect of the present disclosure, a digital indication is received by a remote device.

According to yet another aspect of the present disclosure, a locating feature includes a magnetic locating feature that interacts with a complementary locating feature on a transmitting assembly.

According to another aspect of the present disclosure, at least one of a controller and a control unit of the receiving assembly is configured to determine a coupling coefficient between a transmitting assembly and a receiving assembly and transmits the coupling coefficient to a remote location.

According to still another aspect of the present disclosure, at least one of a controller and a control unit is configured to modulate a magnitude of electromagnetic fields generated between a transmitting assembly and a receiving assembly based on a coupling coefficient.

According to another aspect of the present disclosure, a powering system for a facility includes a patient support apparatus with a controller and a patient support. One of a powered energy source and a rechargeable battery is embedded within the patient support. The controller is in communication with one of the powered energy source and the rechargeable battery. A transmitting assembly is coupled to the patient support apparatus and one of the powered energy source and the rechargeable battery. A receiving assembly is embedded within the patient support. The transmitting assembly wirelessly communicates with the receiving assembly via capacitive resonant coupling to power features of the patient support. A locating feature is in communication with the controller of the patient support apparatus. The locating feature is configured to indicate when the receiving assembly is in communication with the transmitting assembly.

According to still another aspect of the present disclosure, patient support apparatus includes a bed frame that has a support surface. A transmitting assembly is coupled to the bed frame, a mattress is selectively positioned on the support surface, and a controller is communicatively coupled to the transmitting assembly. A sensor assembly is coupled to the mattress and is configured to sense information about at least one of the mattress and a person positioned on the mattress. A receiving assembly is embedded within the mattress and is in communication with the sensor assembly. The receiving assembly is configured to selectively interact with the transmitting assembly via one of inductive coupling and capacitive coupling to power the sensor assembly.

According to yet another aspect of the present disclosure, information related to features of a bed frame are transmitted to a mattress.

According to another aspect of the present disclosure, information transmitted by a bed frame is used to calculate an optimized setpoint of a function carried out by a mattress.

According to still another aspect of the present disclosure, function of a mattress includes at least one of a turn assist function, a percussion function, a vibration function, and a continuous lateral rotation therapy function.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A power supply system for a facility, comprising:
a patient support apparatus including a controller and a patient support;
a power source operably coupled to the patient support apparatus, wherein the controller is in communication with the power source;
a transmitting assembly coupled to the patient support apparatus and the power source;
a receiving assembly operably coupled to the patient support, wherein the transmitting assembly wirelessly communicates with the receiving assembly to power the patient support; and
a locating feature in communication with the controller of the patient support apparatus, wherein the locating feature is configured to aid in aligning the power source on the patient support apparatus to indicate when the receiving assembly is in communication with the transmitting assembly.

2. The power supply system of claim 1, wherein the locating feature is configured to guide the receiving assembly into communication with the transmitting assembly.

3. The power supply system of claim 1, wherein the locating feature includes one of an audible, tactile, and visual indication that confirms communication between the receiving assembly and the transmitting assembly.

4. The power supply system of claim 1, wherein the receiving assembly and the transmitting assembly are configured to communicate via capacitive coupling to charge the power source.

5. The power supply system of claim 1, wherein the locating feature includes a magnetic locating feature on one of the receiving assembly and the transmitting assembly that interacts with a complementary locating feature on the other of the receiving assembly and the transmitting assembly.

6. The power supply system of claim 1, wherein the locating feature includes a snap-fit connection between the receiving assembly and the transmitting assembly that locates the patient support relative to the patient support apparatus.

7. The power supply system of claim 1, further comprising:
an indicator device operably coupled to at least one of the patient support apparatus, the power source, the receiving assembly, and the transmitting assembly, wherein the indicator device illuminates when the receiving assembly and the transmitting assembly are in communication.

8. The power supply system of claim 1, further comprising:
a sensor operably coupled to the receiving assembly, wherein the sensor is configured to sense at least one of an electric field, a magnetic field, and an electromagnetic field emitted by the transmitting assembly.

9. The power supply system of claim 1, wherein the patient support includes a microclimate management system.

10. The power supply system of claim 1, wherein an interface defined between the receiving assembly and the transmitting assembly is smooth and free of any plug and receptacle power connection thereby enhancing cleanability and reducing bioburden.

11. A patient support apparatus powering system, comprising:
a frame;
a patient support disposed on the frame;
a wheel coupled to the frame and configured to engage a floor surface;
a controller;
a rechargeable battery coupled to a patient support apparatus and in communication with the controller;
a receiving assembly coupled to the patient support and including a locating feature operably coupled to the frame, wherein the receiving assembly is in communication with the rechargeable battery;
a transmitting assembly operably coupled to the frame and including a complementary locating feature configured to aid a caregiver in aligning the receiving assembly adjacent to the transmitting assembly such that the transmitting assembly is in electrical communication with the receiving assembly.

12. The patient support apparatus powering system of claim 11, wherein the rechargeable battery is configured to be recharged from said patient support apparatus powering system.

13. The patient support apparatus powering system of claim 11, wherein the locating feature includes a magnetic locating feature that interacts with the complementary locating feature on the transmitting assembly.

14. The patient support apparatus powering system of claim 11, wherein the locating feature includes generally smooth surfaces through which at least one of data and power are transferred from the transmitting assembly to the receiving assembly.

15. The patient support apparatus powering system of claim 11, wherein the transmitting assembly includes a transmitting planar surface and the receiving assembly includes a receiving planar surface that is in abutting contact with the transmitting planar surface, and wherein at least one of data and power are transferred through the transmitting planar surface to the receiving planar surface.

16. The patient support apparatus powering system of claim 15, further comprising:
an indicator device operably coupled to at least one of the patient support apparatus, the rechargeable battery, the receiving assembly, and the transmitting assembly, wherein the indicator device sends a signal when the receiving assembly and the transmitting assembly are in communication.

17. A patient support apparatus, comprising:
a bed frame having a support surface;
a transmitting assembly coupled to the bed frame;
a mattress selectively positioned on the support surface;
a controller communicatively coupled to the transmitting assembly;
a sensor assembly coupled to the mattress and configured to sense information about at least one of the mattress and a person positioned on the mattress; and
a receiving assembly embedded within the mattress and in communication with the sensor assembly, wherein the receiving assembly is configured to selectively interact with the transmitting assembly via one of inductive coupling and capacitive coupling to power the sensor assembly.

18. The patient support apparatus of claim 17, wherein information related to features of the bed frame are transmitted to the mattress, and wherein at the surface of the mattress at least one of bladder pressure, blower speed, power control, temperature and humidity sensing, immersion sensing, pressure mapping, patient position, patient vital signs, fluid ingress detection, mattress surface diagnostics, and modes, functions, and controls of the bed frame is measured.

19. The patient support apparatus of claim 18, wherein the information transmitted by the bed frame is used to calculate an optimized setpoint of a function carried out by the mattress.

20. The patient support apparatus of claim 19, wherein function of the mattress includes at least one of a turn assist function, a percussion function, a vibration function, and a continuous lateral rotation therapy function.
